(19) United States
(12) Patent Application Publication
(10) Pub. No.: US 2013/0289818 A1
(43) Pub. Date: Oct. 31, 2013

(54) METHOD AND SYSTEM FOR AUTOMATICALLY GUIDING AN UNMANNED VEHICLE

(71) Applicant: Israel Aerospace Industries Ltd., (US)

(72) Inventors: Dina APPLEMAN, Bat-Yam (IL); Alex PINSKY, Lapid (IL); Arkady SIGAL, Rishon-Lezion (IL); Arieh TSENTSIPER, Modi'in (IL)

(21) Appl. No.: 13/854,505

(22) Filed: Apr. 1, 2013

Related U.S. Application Data
(63) Continuation of application No. 11/917,978, filed on Apr. 19, 2010, now abandoned.

(30) Foreign Application Priority Data
Jun. 19, 2005 (IL) 169269

(51) Int. Cl. G05D 1/02

(52) U.S. Cl. CPC G05D 1/02
USPC 701/25; 701/472

(57) ABSTRACT

An unmanned vehicle is guided by selecting locations along a predetermined mute defining adjacent first, second and third linear portions. If an imaginary circle can be constructed that is mutually tangential to all three linear portions or to projections thereof, the vehicle is guided according to the circle intercept method until it reaches an imaginary point of contact (M) between the circle and the second linear portion or passes its traverse. If an imaginary circle cannot be constructed that is mutually tangential to all three linear portions or to projections thereof, an imaginary circle is constructed that is mutually tangential to the first and second linear portions; and the vehicle is guided along according to the leg intercept method until it reaches an imaginary point of contact (M) between the circle and the first linear portion or passes its traverse. The process is repeated iteratively in respect of successive locations

### FIELD OF THE INVENTION

This invention relates to automatic guidance of unmanned vehicles.

### BACKGROUND OF THE INVENTION

U.S. Pat. No. 6,453,238 (Brodie et al.) published Sep. 17, 2002 describes a navigation system for tracking the position of an object using a GPS receiver responsive to GPS signals for periodically providing updates to a navigation processor. The system also includes a dead reckoning sensor (beacon) responsive to movement of the object providing updates to a navigation processor. The navigation processor determines object navigation states and propagates the object navigation states between measurement updates using the movement measurements. The navigation system mimics the traditional Kalman filter by integrating separate GPS-navigation, heading and speed Kalman filters.

U.S. Pat. No. 5,923,270 (Sampo et al.) published on Jul. 13, 1999 discloses an automatic steering system for unmanned vehicle that carries a navigation computer which receives positional information from an external positioning systems. A navigation computer and the ground station computer provide the vehicle with predetermined path. An established path as received from the external positioning system is compared with the predetermined one and the vehicle navigation is modified for compensating the deviations.

U.S. Pat. No. 4,700,302 (Arakawa et al.) published Oct. 13, 1987 discloses an automatic guidance system for an unmanned vehicle that causes the unmanned vehicle to move to a destination by a combination of traveling along a preset course, and turning and stopping at predetermined positions. A running control unit is provided to minimize the predicted vehicle position deviation for one step ahead. This is done by determining optimal control values in such a manner that a running state of the unmanned vehicle after a predetermined period of time is predicted by changing control values set in a drive unit in accordance with state values (e.g., position information and heading angle information) representing the current running state, and that the running state after the predetermined period of time matches with the directed operation of the unmanned vehicle, thereby accurately guiding the unmanned vehicle along the preset path.

U.S. Pat. No. 6,539,294 (Kageyama) published Mar. 25, 2003 and entitled “Vehicle guidance system for avoiding obstacles stored in memory” discloses a guiding apparatus that guides a vehicle to avoid obstruction based on obstruction position data stored in memory and updated by an updating unit. In guiding the vehicle between a source position Sₚ and a target position Tₚ, the system randomly allocates an intermediate position Mₚ and generates a course that includes the source position Sₚ and the intermediate position M. As described with reference to FIG. 18, a circle is drawn that is tangential to the direction vectors at both the source position Sₚ and the intermediate position Mₚ and whose connecting arc serves as the navigation path.

It thus emerges that construction of circles that bound adjacent segments of a route is known for the purpose of determining a route along which an unmanned vehicle may be guided between the segments.

It would therefore be desirable to provide a simpler method and system for guiding an unmanned vehicle.

Control systems require feedback to maintain stability and equilibrium. Kalman filters are commonly used in navigation systems since they yield control systems with guaranteed performance by solving formal matrix design equations which generally have unique solutions. An example of such an approach is described in U.S. Pat. No. 6,205,401 (Pickhard et al.) published Mar. 20, 2001 and entitled “Navigation system for a vehicle, especially a land craft”. This reference discloses a navigation system having at least one single-axis gyro for the vehicle vertical axis (z axis), having two accelerometers in the horizontal vehicle plane (x axis, y axis), and having a vehicle-axis velocity measurement device, for example, a distance-traveled sensor. In addition, supporting signal devices, in particular a satellite receiver and/or a map, are available as well as a controller, which uses a suitable Kalman filter to determine the vehicle position and/or the direction of travel from the measured and stored signals. The Kalman filter is assigned at least one partial filter, of which a first partial filter is used for dynamic leveling and/or a second partial filter is designed as a position filter which provides track calibration, position calibration and sensor calibration.

The Kalman filer, especially extended, while having many advantages, is complex, requires a lot of matrix operations (the matrix size depending on state vector and measurement vector size), and is unstable in cases where the measurement deviation is larger than the predefined error limits.

It would therefore be desirable to employ an alternative filter that is less demanding of computer resources than the extended Kalman filter and remains stable even in conditions where the Kalman filter is apt to become unstable.

### SUMMARY OF THE INVENTION

It is a first object of the present invention to provide an improved method and system for automatically guiding an unmanned vehicle along a predetermined route.

This objective is realized by a method for automatically guiding an unmanned vehicle along a predetermined route, the method comprising:
(a) selecting first, second, third and fourth locations along said route defining adjacent first, second and third linear portions for a current iteration such that the first and second linear portions meet at the second location and the second and third linear portions meet at the third location;
(b) if an imaginary circle can be constructed that is mutually tangential to all three of said first, second and third linear portions or to projections thereof:
   i) guiding the vehicle according to the circle intercept method as herein defined until it reaches an imaginary point of contact (M) between said circle and the second linear portion or passes its traverse; and
   ii) thereafter selecting a fifth location along the route so that the second, third, fourth and fifth locations of the current iteration respectively constitute said first, second, third and fourth locations of a successive iteration and repeating from (b);
(c) if an imaginary circle cannot be constructed that is mutually tangential to all three of said first, second and third linear portions or to projections thereof:
   i) constructing an imaginary circle that is mutually tangential to the first and second linear portions;
   ii) guiding the vehicle along according to the leg intercept method as herein defined until the vehicle reaches an imaginary point of contact (M) between said circle and the first linear portion or passes its traverse; and
   iii) thereafter selecting a fifth location along the route so that the second, third, fourth and fifth locations of the current iteration respectively constitute said first, second, third and fourth locations for a successive iteration and repeating from (b).

The invention uses a sliding window type of prediction for a set of four points and develops an equation that fits the required path, followed by the control command.

It is a second object of the invention to provide an improved filter for use in an automatic vehicle guidance system.

This objective is realized by a method for automatically guiding a vehicle along a predetermined route, the method comprising:
(a) obtaining successive current speed and wheel angle signals of the vehicle;
(b) obtaining successive current angle signals from an inertial navigation system;
(c) obtaining current successive digital GPS velocity and position signals;
(d) filtering said signals to derive a current velocity signal of the vehicle;
(e) integrating the current velocity signal to determine a predicted vehicle position;
(f) comparing the predicted vehicle position with a current sensed position of the vehicle as determined by one or more vehicle positioning sensors;
(g) if a difference between the predicted vehicle position and the current sensed position of the vehicle exceeds a predetermined threshold, then:
   i) if the computed current position remains stable for a predetermined number of successive iterations, using the computed current position for position filtering, vehicle control generation and in a subsequent iteration; and
   ii) otherwise eliminating the computed current position;
(h) determining a new position of the vehicle as a weighted average of the respective sensed positions; and
   (i) using the new position to control the vehicle.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1a and 1b show schematically alternative path segments derived from four consecutive coordinates of a predetermined vehicle trajectory;

FIGS. 2a and 2b show schematically navigation using circle interception and leg interception, respectively;

FIG. 3 is a flow diagram showing the principal operations carried out by a method for navigating a vehicle along a predetermined trajectory in accordance with a first embodiment of the invention;

FIG. 4 is a block diagram showing the functionality of a navigation data filter according to a second embodiment of the invention;

FIG. 5 is a flow diagram showing the principal operations carried out by the navigation filter shown in FIG. 4;

FIG. 6 is a flow diagram showing in greater detail a method for velocity filtering for use by the navigation filter shown in FIG. 4;

FIG. 7 is a flow diagram showing in greater detail a method for azimuth filtering for use by the navigation filter shown in FIG. 4; and

FIG. 8 is a flow diagram showing in greater detail a method for computing a velocity component for use by the navigation filter shown in FIG. 4.

### DETAILED DESCRIPTION OF EMBODIMENTS

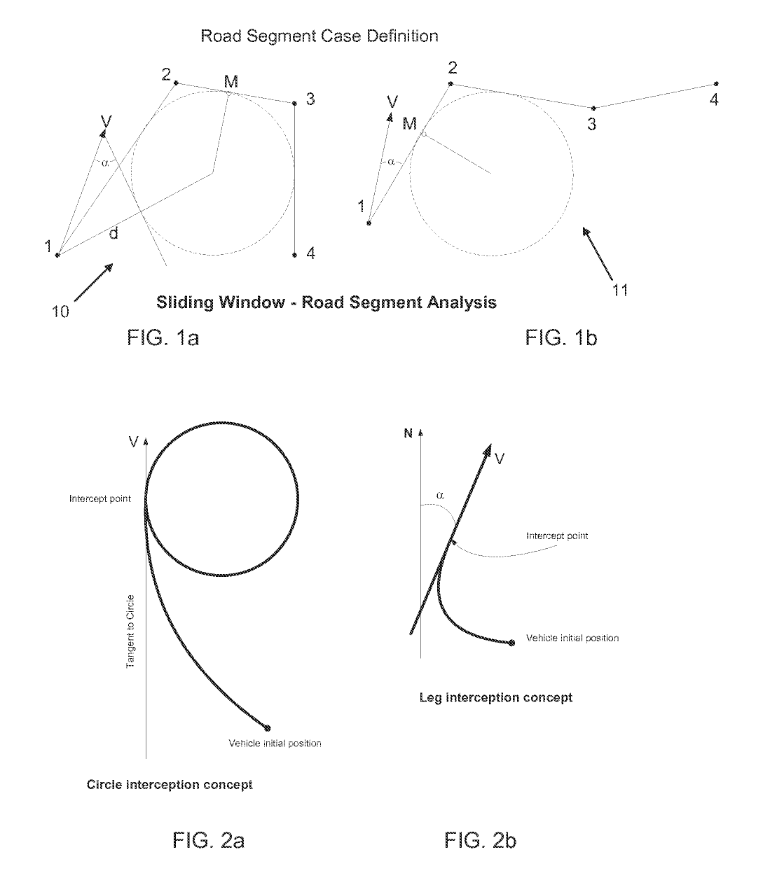

FIGS. 1a and 1b show schematically a pair of sliding windows 10, 11 each defining alternative path segments derived from four consecutive coordinates 1, 2, 3 and 4 of a vehicle trajectory. Also shown in both of the sliding windows 10, 11 is a point M that constitutes a breakpoint to which the vehicle is guided for so long as its current position is behind the breakpoint M. Once the current position is in front of the breakpoint M i.e. the vehicle has advanced past the breakpoint M, a new sliding window is selected and the breakpoint M is moved forward. Each sliding window defines three successive segments denoted by coordinate pairs (1, 2), (2, 3) and (3, 4). Denoting the respective bearings of these three segments by the notation β₁₂, β₂₃ and β₃₄, the angle between the two segments (1, 2) and (2, 3) denoted by Ψ₁₂₃ is given by:

Ψ₁₂₃=β₁₂−β₂₃

Likewise, the angle between the two segments (2, 3) and (3, 4) denoted by Ψ₂₃₄ is given by:

Ψ₂₃₄=β₂₃−β₃₄

In accordance with the invention, there are two different approaches to guiding the vehicle on to the correct trajectory depending on whether the product of the angles Ψ₁₂₃,Ψ₂₃₄ is greater than or less than zero as represented by the sliding windows 10 and 11 shown in FIG. 1a and in FIG. 1b, respectively. These two approaches will be described in detail with particular reference to FIG. 2 but before doing so, some empirical explanation of the approaches may help.

In the simpler sliding window 10 shown in FIG. 1a, the object is to guide the vehicle around an imaginary circle 12 that is tangential to all three segments (1, 2), (2, 3) and (3, 4) or to projections thereof.

At each vehicle position two parameters are analyzed: the first is an angle between the vehicle velocity vector and the tangent to the circle at the point of intersection of the direction line connecting the vehicle position to the center of the imaginary circle (α); the second is the distance from the vehicle position to the nearest tangent to the circle (d).

The vehicle is guided to the breakpoint M placed on the second segment (2, 3) by generating the wheel control command according to the values of the above parameters. The traverse of the breakpoint M corresponds to any line that passes through the breakpoint M perpendicular to the segment containing the breakpoint M—in this case the segment (2, 3). When the vehicle passes the traverse of the breakpoint M, the sliding window is moved to the next point in the trajectory such that the second segment (2, 3) now becomes the first segment of the next sliding window and the process repeats. The breakpoint M always lies on the imaginary circle 12. So, if the vehicle moves off track, it will always be guided to intercept the circle so as to intersect the breakpoint M (or to pass its traverse as close as possible to it). This kind of navigation is known as circle interception and the wheel angle command that must be fed to the steering system is defined by:

1. Distance to the nearest tangent to the circle

2. Difference between the vehicle heading and the tangent bearing

3. Radius of the circle

On the other hand, in the case shown in FIG. 1b, successive segments of the trajectory do not close in on each other and the vehicle is guided according to the relative angular bearing between adjacent segments. In this case, the breakpoint M always lies on the first straight line segment (1, 2) in the current window 11 and corresponds to the point where the segment (1, 2) meets an imaginary circle 13. So, if the vehicle moves off track, it will always be guided to intersect the first segment (1, 2) so as to intersect the breakpoint M or to pass its traverse. This kind of navigation is known as leg interception and the wheel angle command that must be fed to the steering system is defined by:

1. Distance to the segment (leg)

2. Difference between the vehicle heading and the segment bearing.

It should be emphasized that the size of the segment (distance between the points) is of the same order as the distance traveled by the vehicle in one second (vehicle velocity in meters/sec). Thus, the current measurement rate allows about 10 to 20 steering commands per segment to be generated.

The foregoing description makes reference to navigation using the circle interception and leg interception methods. FIG. 2a shows schematically that in the circle intercept concept the vehicle should intercept the circle in a way that its velocity vector V coincides with the tangent to the circle at the interception point. FIG. 2b shows schematically that in the leg intercept concept the vehicle should intercept the leg in a way that its velocity vector V coincides with the leg (velocity vector direction equal to the leg bearing).

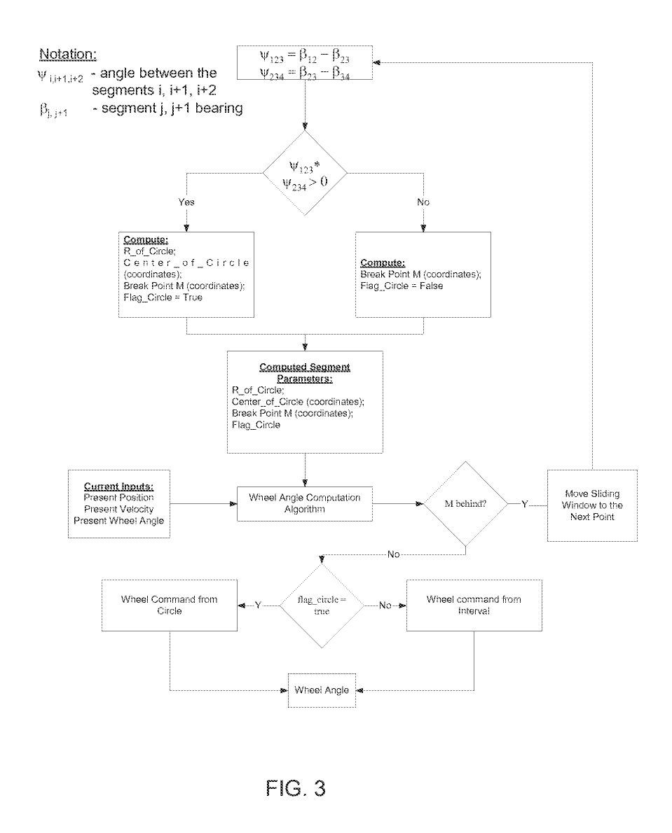

FIG. 3 is a flow diagram showing the principal operations carried out by a method according to an exemplary embodiment of the invention for navigating a vehicle along a predetermined trajectory. The algorithm computes the bearings of each of the three segments in the current window, computes the product of the angles Ψ₁₂₃ ,Ψ₂₃₄ and determines whether the current window conforms to the situation shown in FIG. 1a requiring circle intersection or to the situation shown in FIG. 1b requiring leg intersection. In the case that circle intersection is required the algorithm computes the radius and center of the unique circle 12 as well as the coordinates of the breakpoint M and sets an internal flag Flag_Circle to TRUE.

In the case that leg intersection is required the algorithm computes the coordinates of the breakpoint M and sets an internal flag Flag_Circle to FALSE. In this case, there is theoretically an infinite number of circles of different radii and center coordinates that can be tangential to the first two segments (1, 2) and (2, 3) in the current window.

In both cases, the circle radius and center, the coordinates of the breakpoint M and the logical value of Flag_Circle are fed to a wheel angle computation algorithm that is responsive also the vehicle's present position and velocity for steering the vehicle towards the breakpoint M. The vehicle continues along the path determined by the wheel angle computation algorithm until it passes the breakpoint M, i.e. until the breakpoint M is behind the vehicle's present position. When this occurs, the first segment (1, 2) is discarded since the vehicle has now navigated past this segment, a new sliding window is defined starting at the previous second segment (2, 3) and including the next segment and the process repeats.

Prior to the vehicle passing the breakpoint M, the wheel command fed to the vehicle steering mechanism depends on the value of Flag_Circle. If Flag_Circle is TRUE, the wheel command is determined based on the radius and center of the circle 11 as to guide the vehicle along the circle 11. If Flag_Circle is FALSE, the wheel command is determined based on the angle between the vehicle velocity direction and the leg bearing (α) and the distance from the vehicle's present position to the leg so as to guide the vehicle along the current first segment (1, 2).

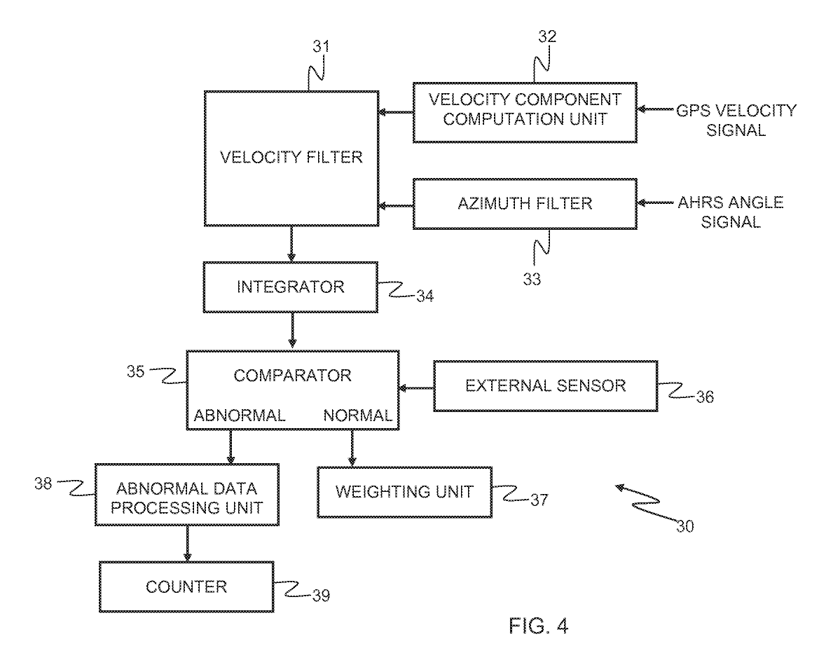

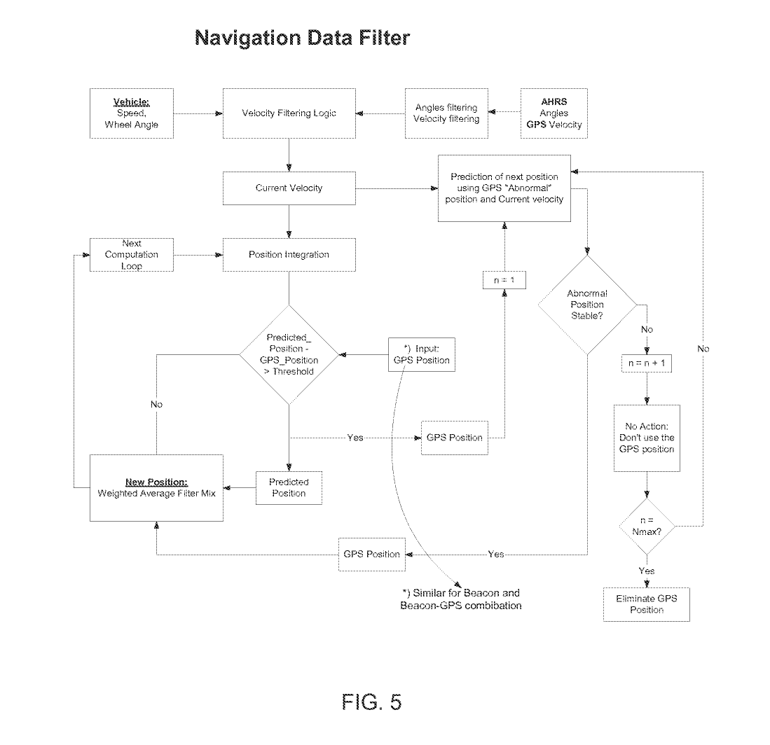

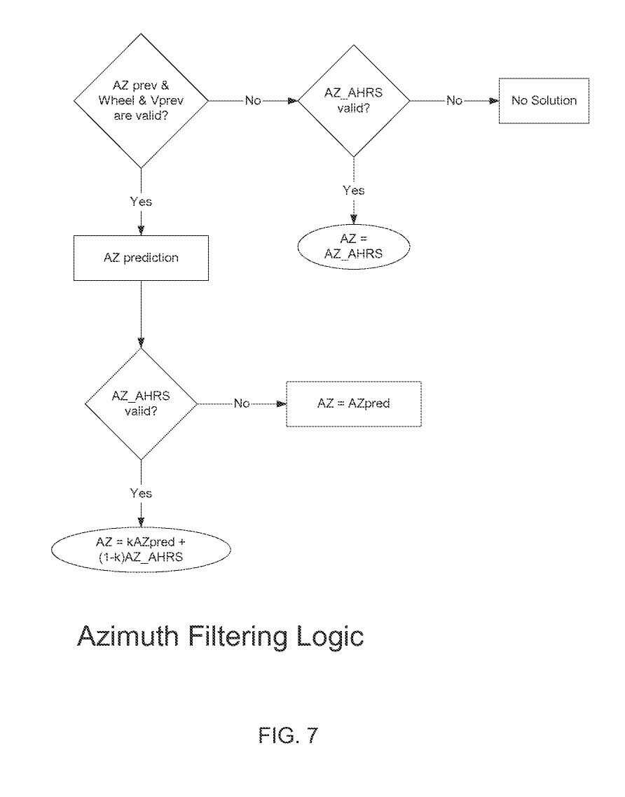

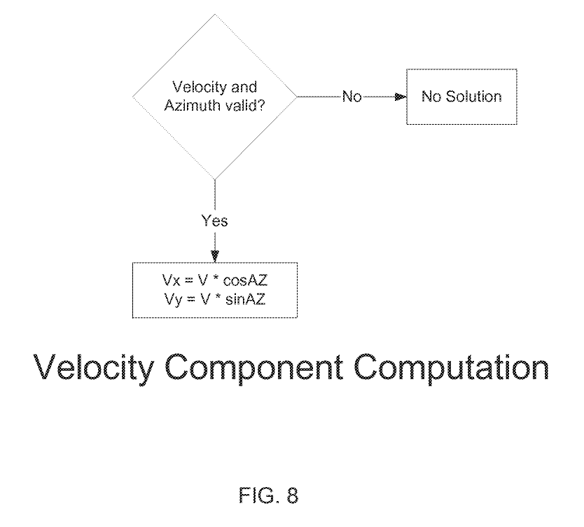

FIG. 4 is a block diagram showing the functionality of a navigation data filter 30 according to a second exemplary embodiment of the invention whose operation will be described with reference to FIG. 5. The navigation data filter 30 includes a velocity filter 31, which receives as inputs signals indicative of vehicle speed and wheel angle as well as GPS velocity signals and AHRS angle signals via a velocity component computation unit 32 and an azimuth filter 33, respectively. Operation of the velocity component computation unit 32 and the azimuth filter 33 is described below with reference to FIGS. 7 and 8, respectively. The AHRS is an inertial navigation unit located on the vehicle and coupled to a magnetometer. Its outputs (measurements) are used as an input to the velocity filter 31. An integrator 34 is coupled to the velocity filter 31 for integrating a current velocity signal output thereby so as to produce a predicted position signal. One or more comparators 35 determine whether the difference between the predicted position and one or more sensed positions as received from a respective external sensor 36 exceeds a predetermined threshold. In the normal case where the difference between the predicted position and the sensed position as received from the external sensors 36 is within the prescribed limit, the sensed positions and the predicted position are fed to a weighting unit 37 coupled to an output of the comparator 35. The weighting unit 37 computes a new position that is a weighted average of the input signals. The integrated position is compared with the sensed positions as provided by the external sensors 36 e.g. the GPS/beacon sensors, while the “new position” is the filtered position obtained by a weighted averages filter. If the difference between the predicted position and the sensed position as received from the external sensors 36 is outside the prescribed limit, this represents an abnormal condition. In this case, the current velocity derived from the velocity filter 31 is fed to an abnormal data processing unit 38 which determines whether the abnormal position is stable. The stability is defined by following the GPS data during a predetermined maximum number of measurement cycles. If the abnormal position is stable, the sensed position is fed to the weighting unit 37 which computes a new position that is a weighted average of the input signals including any abnormal sensed positions. If the abnormal sensed position is unstable for a predetermined number of iterations as determined by a counter 39, no action is taken whereby the sensed position is omitted from further analysis.

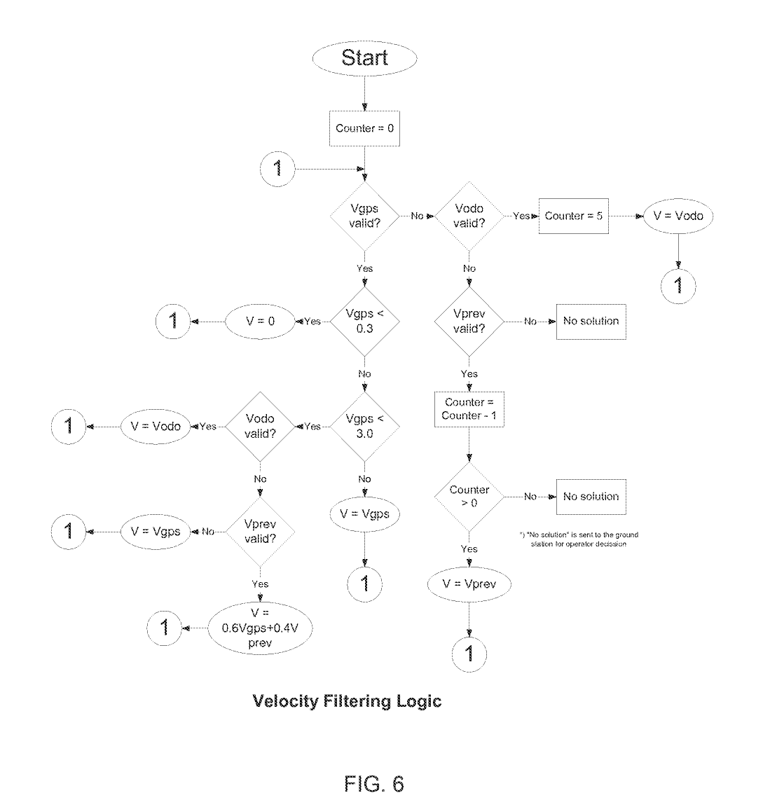

FIG. 6 is a flow diagram showing in greater detail a method for velocity filtering for use by the navigation filter 30 shown in FIG. 4. A counter is initialized to zero. If the GPS velocity is valid and is less than 0.3 meters/sec the filter velocity V is set to zero and the next GPS velocity signal is processed. If the GPS velocity is not greater than 0.3 meters/sec but less than 3 meters/sec, then the vehicle speed as determined by its odometer is considered. The odometer speed is considered valid if the speed signal is successfully received, decoded, and the sensor validity flag is “OK”. If the current odometer speed is valid, the filter velocity V is set to the current odometer speed and the next GPS velocity signal is processed. If the current odometer speed and the previous filter velocity are not valid, then the filter velocity V is set to the GPS velocity and the next GPS velocity signal is processed. If the current odometer speed is not valid but the previous filter velocity was valid, then the filter velocity V is set to an average weighted value given by V=0.6V_{GPS}+0.4V_{PREV} and the next GPS velocity signal is then processed. If the GPS velocity is greater than 3, then the filter velocity V is set to the current GPS velocity and the next GPS velocity signal is processed.

If the current GPS velocity signal is not valid, but the current odometer speed is valid, then the counter is set to 5, the filter velocity V is set to the current odometer speed and the next GPS velocity signal is processed. If neither the current GPS velocity signal nor the current odometer speed is valid, but the previous filter velocity V was valid, then the counter is decremented by one and for so long as the counter value is greater than zero, the filter velocity V is set to its previous value. In effect this means that where the current odometer speed is invalid, the filter velocity V is set to the previous valid odometer speed providing that the odometer speed is not invalid for more than five iterations. Otherwise, in either of the cases where the previous filter velocity V was not valid or the counter is not greater than zero, there is no algorithmic solution and the filter velocity V is sent to the ground station operator for manual intervention.

FIG. 7 is a flow diagram showing operation of the azimuth filter 33. If the previous azimuth position, the current wheel position and the previous filter velocity V are all valid, then the azimuth position is predicted. If the AHRS azimuth position as obtained from the inertial navigation unit is valid, then the current azimuth position AZ is set to a weighted average of the predicted position AZ_{PRED} and the AHRS position AZ_{AHRS} as given by AZ=k·AZ_{PRED}+(1−k)·ZA_{AHRS}. If the AHRS azimuth position AZ_{AHRS} is not valid, then the current azimuth position AZ is set to the predicted value, AZ_{PRED}.

FIG. 8 is a flow diagram showing operation of the velocity component computation unit 32. If the filter velocity V and the azimuth position AZ are both valid, then horizontal and vertical components Vₓ and V_{y} respectively of the filter velocity V are derived by:

Vₓ=V·cos(AZ)

V_{y}=V·sin(AZ)

If any of the previous azimuth position, the current wheel position and the previous filter velocity V are not valid, but the AHRS azimuth position AZ_{AHRS} is valid, then the azimuth position is set to the AHRS azimuth position AZ_{AHRS}. But if the AHRS azimuth position AZ_{AHRS} is also not valid, the there is no solution.

The navigation data filter 30 described above with reference to FIGS. 4 to 8 may be used in an unmanned vehicle navigation system of the type described with reference to FIGS. 1 to 3. However, it may also in a manned vehicle navigation system. For example, it has been tested successfully in a helicopter guidance system having a set of various navigation sensors providing data at different update times.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method for automatically guiding an unmanned vehicle along a predetermined route, the method comprising:
(a) selecting first, second, third and fourth locations along said route defining adjacent first, second and third linear portions for a current iteration such that the first and second linear portions meet at the second location and the second and third linear portions meet at the third location;
(b) if an imaginary circle can be constructed that is mutually tangential to all three of said first, second and third linear portions or to projections thereof:
i) guiding the vehicle according to the circle intercept method as herein defined until it reaches an imaginary point of contact (M) between said circle and the second linear portion or passes its traverse; and
ii) thereafter selecting a fifth location along the route so that the second, third, fourth and fifth locations of the current iteration respectively constitute said first, second, third and fourth locations of a successive iteration and repeating from (b);
(c) if an imaginary circle cannot be constructed that is mutually tangential to all three of said first, second and third linear portions or to projections thereof:
i) constructing an imaginary circle that is mutually tangential to the first and second linear portions;
ii) guiding the vehicle along according to the leg intercept method as herein defined until the vehicle reaches an imaginary point of contact (M) between said circle and the first linear portion or passes its traverse; and
iii) thereafter selecting a fifth location along the route so that the second, third, fourth and fifth locations of the current iteration respectively constitute said first, second, third and fourth locations for a successive iteration and repeating from (b).

2. The method according to claim 1, wherein in c(i) the imaginary circle that is mutually tangential to the first and second linear portions has a radius that is limited by technical properties of the vehicle.

3. The method according to claim 2, wherein the technical properties are included in the group: maximal wheel angle and wheel angle rate.

4. The method according to claim 1, further including:
(d) obtaining successive current speed and wheel angle signals of the vehicle;
(e) obtaining successive current angle signals from an inertial navigation system;
(f) obtaining current successive digital GPS velocity and position signals;
(g) filtering said signals to derive a current velocity signal of the vehicle;
(h) integrating the current velocity signal to determine a predicted vehicle position;
(i) comparing the predicted vehicle position with a current sensed position of the vehicle as determined by one or more vehicle positioning sensors;
(j) if a difference between the predicted vehicle position and the current sensed position of the vehicle exceeds a predetermined threshold, then:
i) if the computed current position remains stable for a predetermined number of successive iterations, using the computed current position for position filtering, vehicle control generation and in a subsequent iteration; and
ii) otherwise eliminating the computed current position;
(k) determining a new position of the vehicle as a weighted average of the respective sensed positions; and
(l) using the new position to control the vehicle.

5. The method according to claim 4, wherein the sensed position is derived by one or more in the group: digital GPS position sensor; beacon sensor.

6. A method for automatically guiding a vehicle along a predetermined route, the method comprising:
(a) obtaining successive current speed and wheel angle signals of the vehicle;
(b) obtaining successive current angle signals from an inertial navigation system;
(c) obtaining current successive digital GPS velocity and position signals;
(d) filtering said signals to derive a current velocity signal of the vehicle;
(e) integrating the current velocity signal to determine a predicted vehicle position;
(f) comparing the predicted vehicle position with a current sensed position of the vehicle as determined by one or more vehicle positioning sensors;
(g) if a difference between the predicted vehicle position and the current sensed position of the vehicle exceeds a predetermined threshold, then:
i) if the computed current position remains stable for a predetermined number of successive iterations, using the computed current position for position filtering, vehicle control generation and in a subsequent iteration; and
ii) otherwise eliminating the computed current position;
(h) determining a new position of the vehicle as a weighted average of the respective sensed positions; and
(i) using the new position to control the vehicle.

7. The method according to claim 6, wherein the sensed position is derived by one or more in the group: digital GPS position sensor; beacon sensor.

8. A navigation data filter comprising:
a velocity filter having inputs for receiving signals indicative of vehicle speed and wheel angle as well as GPS velocity signals;
a velocity component computation unit for receiving angle signals from an inertial navigation unit and feeding to an input of the velocity filter;
an azimuth filter for receiving azimuth signals from the inertial navigation unit and feeding to an input of the velocity filter;
an integrator coupled to the velocity filter for integrating a current velocity signal output thereby so as to produce a predicted position signal;
one or more comparators each coupled to the integrator and to a respective external sensor for determining whether a difference between the predicted position a sensed position as received from a respective one of the external sensors exceeds a predetermined threshold,
a weighting unit coupled to an output of the comparator and being responsive to said difference being within a prescribed limit for computing a new position that is a weighted average of input position signals fed thereto, and
an abnormal data processing unit responsive to said difference being outside said prescribed limit for determining whether the sensed position is stable, and if so for feeding the sensed position to the weighting unit.

9. The navigation data filter according to claim 8, wherein the external sensor is one or more in the group: digital GPS position sensor; beacon sensor.

10. A program storage device readable by machine, tangibly embodying a program of instructions executable by the machine to perform a method for automatically guiding an unmanned vehicle along a predetermined route, the method comprising:
(a) selecting first, second, third and fourth locations along said route defining adjacent first, second and third linear portions for a current iteration such that the first and second linear portions meet at the second location and the second and third linear portions meet at the third location;
(b) if an imaginary circle can be constructed that is mutually tangential to all three of said first, second and third linear portions or to projections thereof:
i) guiding the vehicle according to the circle intercept method as herein defined until it reaches an imaginary point of contact (M) between said circle and the second linear portion or passes its traverse; and
ii) thereafter selecting a fifth location along the route so that the second, third, fourth and fifth locations of the current iteration respectively constitute said first, second, third and fourth locations of a successive iteration and repeating from (b);
(c) if an imaginary circle cannot be constructed that is mutually tangential to all three of said first, second and third linear portions or to projections thereof:
i) constructing an imaginary circle that is mutually tangential to the first and second linear portions;
ii) guiding the vehicle along according to the leg intercept method as herein defined until the vehicle reaches an imaginary point of contact (M) between said circle and the first linear portion or passes its traverse; and
iii) thereafter selecting a fifth location along the route so that the second, third, fourth and fifth locations of the current iteration respectively constitute said first, second, third and fourth locations for a successive iteration and repeating from (b).

11. A program storage device readable by machine, tangibly embodying a program of instructions executable by the machine to perform a method for automatically guiding a vehicle along a predetermined route, the method comprising:
(a) obtaining successive current speed and wheel angle signals of the vehicle;
(b) obtaining successive current angle signals from an inertial navigation system;
(c) obtaining current successive digital GPS velocity and position signals;
(d) filtering said signals to derive a current velocity signal of the vehicle;
(e) integrating the current velocity signal to determine a predicted vehicle position;
(f) comparing the predicted vehicle position with a current sensed position of the vehicle as determined by one or more vehicle positioning sensors;
(g) if a difference between the predicted vehicle position and the current sensed position of the vehicle exceeds a predetermined threshold, then:
i) if the computed current position remains stable for a predetermined number of successive iterations, using the computed current position for position filtering, vehicle control generation and in a subsequent iteration; and
ii) otherwise eliminating the computed current position;
(h) determining a new position of the vehicle as a weighted average of the respective sensed positions; and
(i) using the new position to control the vehicle.
